(19) United States
(12) Patent Application Publication
(10) Pub. No.: US 2009/0314295 A1
(43) Pub. Date: Dec. 24, 2009

(54) POWERED AIR PURIFYING RESPIRATOR

(75) Inventor: Tom Hatmaker, Georgetown, KY (US)

Correspondence Address: STITES & HARBISON, PLLC, 400 W MARKET ST, SUITE 1800, LOUISVILLE, KY, 40202-3352, US

(73) Assignee: E.D. BULLARD COMPANY, Cynthiana, KY (US)

(21) Appl. No.: 11/959,644

(22) Filed: Dec. 19, 2007

(51) Int. Cl. A62B 7/10

(52) U.S. Cl. 128/205.12

(57) ABSTRACT

A powered air purifying respirator includes a housing defining an air inlet and an air outlet; a filter assembly operably connected to the housing for removing contaminants from air passing therethrough; an impeller/motor assembly contained within the housing for drawing air through the air inlet and through the filter; a flow sensor contained within the housing for measuring air flow from the air inlet to the air outlet; and a liner contained within the housing for locating and retaining the various internal components, while also aiding in attenuating a force of impact to the housing, the liner further defining an air pathway from the impeller/motor assembly through the flow sensor and to the air outlet.

### BACKGROUND OF THE INVENTION

The present invention relates to a powered air purifying respirator (PAPR).

A PAPR is designed to protect the health of a user and to control diseases caused by breathing air contaminated with harmful dusts, fogs, fumes, mists, gases, smokes, sprays, or vapors by drawing ambient air through a filter and then delivering filtered air to the breathing zone of a user. Thus, a PAPR generally includes a housing, a filter, an impeller/motor assembly, and a battery. The battery supplies power to the impeller/motor assembly, which draws ambient air through the filter, with that filtered air then being delivered via a breathing tube to a headpiece worn by the user. The headpiece, which can be in the form of a respirator hood, a mask, a loose fitting facepiece, or a full facepiece, forms a protective barrier between the user and the unfiltered ambient air.

### SUMMARY OF THE INVENTION

The present invention is a powered air purifying respirator (PAPR) with a shock-absorbing liner contained within a housing for locating and retaining the various internal components, while also aiding in attenuating a force of impact to the housing. The shock-absorbing liner also defines an air pathway from an impeller/motor assembly through a flow sensor and to an air outlet, such that the air flow can be monitored and controlled to ensure a requisite air flow.

A PAPR made in accordance with the present invention generally includes a housing, a filter assembly, an impeller/motor assembly, a flow sensor, a shock-absorbing liner, an electronic control board, and a battery. The housing serves as an enclosure for holding the components of the PAPR, including the impeller/motor assembly, flow sensor, the shock-absorbing liner, and the electronic control board. The housing further defines an air inlet and air outlet. The filter assembly is operably connected to the housing at the air inlet to remove contaminants from the ambient air.

The impeller/motor assembly is used for drawing air through the air inlet and through the filter. The shock-absorbing liner is contained within the housing and substantially fills the voids around the various internal components, encasing these components. As such, the liner serves to locate and retain the various internal components, minimizing or eliminating the need for typical retention components, such as brackets and/or mechanical fasteners. Furthermore, the shock-absorbing liner aids in attenuating a force of impact to the PAPR. The shock-absorbing liner protects the PAPR when the PAPR is dropped or strikes an object while in use. The shock-absorbing liner also defines an air pathway from the impeller/motor assembly through the flow sensor and to the air outlet.

The electronic control board controls the operation of the PAPR. The electronic control board is powered by the battery. An on/off switch is located on an external surface of the housing so that it is accessible by the user. This on/off switch is in electrical communication with the electronic control board to allow the user to turn the PAPR on or off. The electronic control board further receives signals from the flow sensor that are representative of the mass flow rate of air through the PAPR. Such signals are analyzed by control logic on the electronic control board, with appropriate control signals then being sent to the impeller/motor assembly to ensure and maintain a requisite air flow.

### DESCRIPTION OF THE DRAWINGS

FIG. 1 is a front view of an exemplary PAPR made in accordance with the present invention;

FIG. 2 is another front view of the exemplary PAPR of FIG. 1, in which the filter assembly has been removed;

FIG. 3 is a rear view of the exemplary PAPR of FIG. 1;

FIG. 4 is a top view of the exemplary PAPR of FIG. 1, including a partial view of a belt assembly for securing the PAPR to a user;

FIG. 5 is a cross-sectional view of the exemplary PAPR of FIG. 1, taken along line 5-5 of FIG. 4;

FIG. 6 is a block diagram of the components of the exemplary PAPR of FIG. 1, illustrating the function of the exemplary PAPR; and

FIG. 7 is another front view of the exemplary PAPR of FIG. 1, including the belt assembly for securing the PAPR to a user.

### DETAILED DESCRIPTION OF THE INVENTION

The present invention is a powered air purifying respirator (PAPR) with a shock-absorbing liner contained within a housing for locating and retaining the various internal components, while also aiding in attenuating a force of impact to the housing. The shock-absorbing liner also defines an air pathway from an impeller/motor assembly through a flow sensor and to an air outlet, such that the air flow can be monitored and controlled to ensure a requisite air flow.

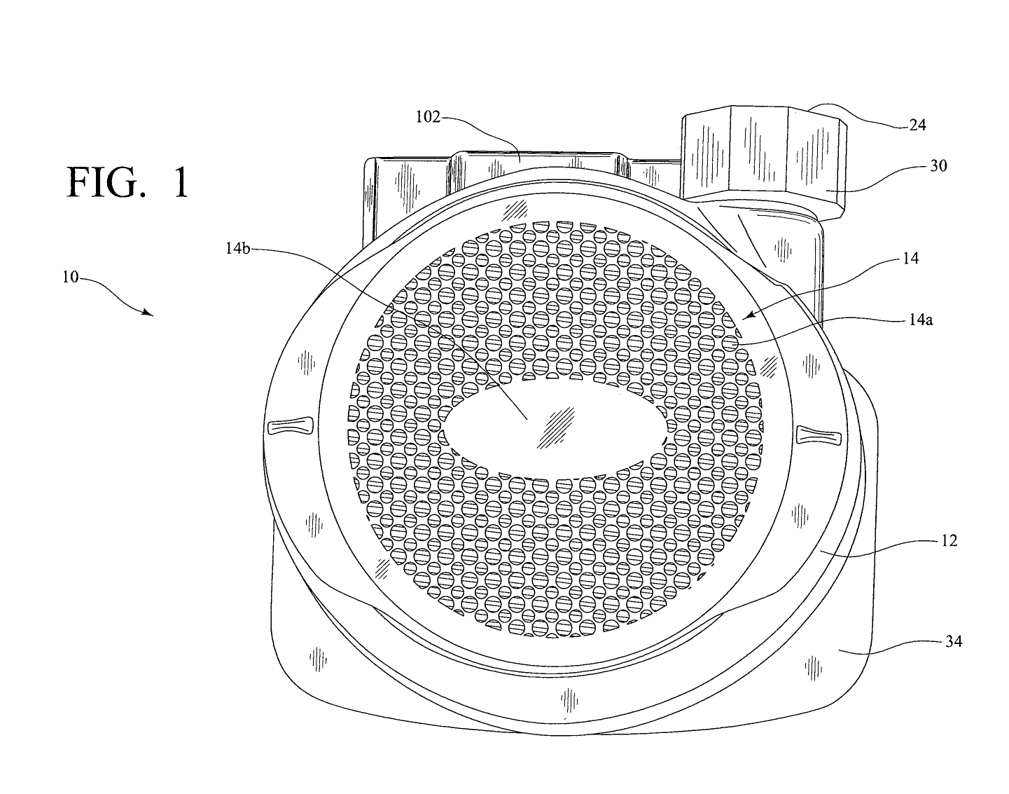

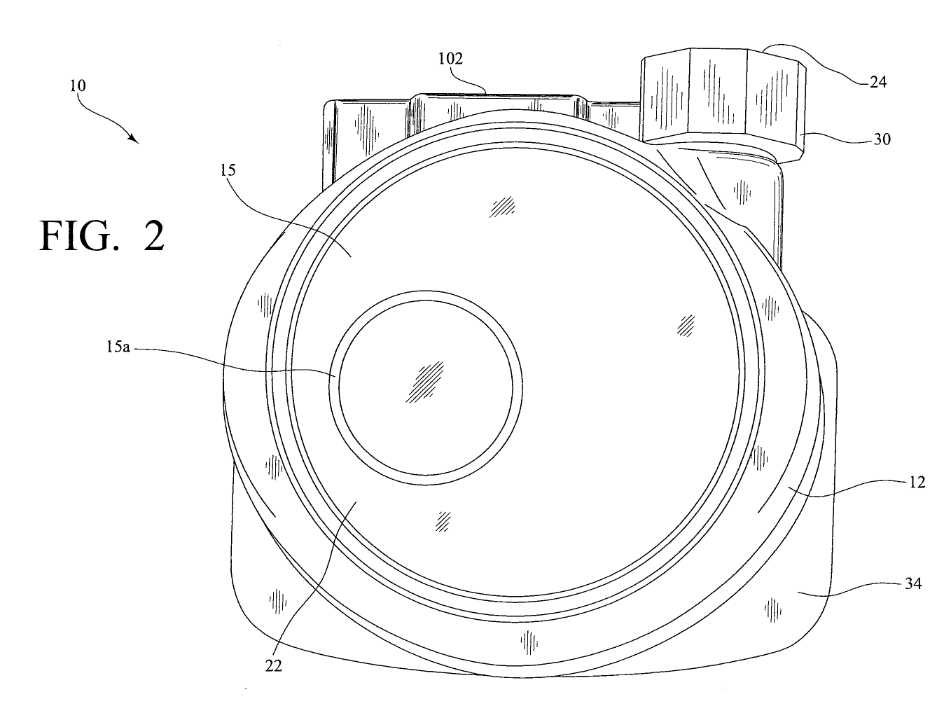

Referring first to FIGS. 1, 2, and 5, an exemplary PAPR 10 made in accordance with the present invention generally includes a housing 12, a filter assembly 14, an impeller/motor assembly 16, a flow sensor 18, a shock-absorbing liner 20, an electronic control board 100, and a power source, such as a battery 102. The housing 12 serves as an enclosure for holding the components of the PAPR 10. The PAPR 10 further defines an air inlet 22, which is a substantially circular opening through the side of the housing 12, as best illustrated in FIG. 2. The PAPR 10 also defines an air outlet 24, as is further described below.

Referring now to FIGS. 1 and 2, the filter assembly 14 (FIG. 1) is operably connected to the housing 12 at the air inlet 22 (FIG. 2), so that ambient air can be drawn into the housing 12 through the filter assembly 14 to remove contaminants from the ambient air. In this exemplary embodiment, the filter assembly 14 is comprised of a HEPA filter media 14a enclosed and maintained in a filter housing 14b. The filter housing 14b supports the filter media 14a and protects the filter media 14a from damage. Of course, other types of filters or filter assemblies could also be used without departing from the spirit and scope of the present invention.

Although not illustrated in the Figures, it should also be recognized that the PAPR 10 could be provided with a waterproof shower cap to cover the filter assembly 14 during decontamination or storage.

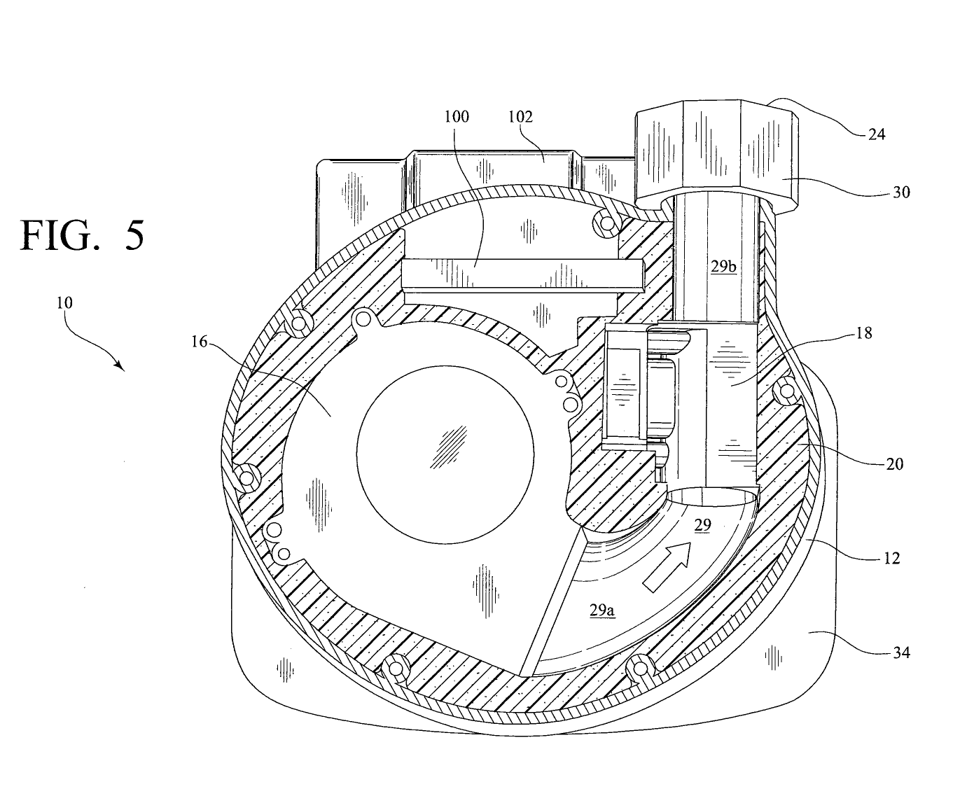

Referring now to the sectional view of FIG. 5, the impeller/motor assembly 16, the flow sensor 18, the shock-absorbing liner 20, and the electronic control board 100 are contained within the housing 12. As mentioned above, the impeller/motor assembly 16 is used for drawing air through the air inlet 22 and through the filter assembly 14. Specifically, and referring again to FIG. 2, there is a plenum 15 that separates the internal components of the PAPR 10 from the filter assembly 14, and this plenum 15 defines an opening 15a for air flow from the filter assembly 14 into the impeller/motor assembly 16. One preferred impeller/motor assembly 16 includes a radial impeller that is dynamically balanced with a brushless motor that drives the impeller, such as Model No. BCB1012UH-7C92 manufactured and distributed by Delta Electronics, Inc. of Taiwan R.O.C.

Referring still to the sectional view of FIG. 5, the shock-absorbing liner 20 is also contained within the housing 12 and substantially fills the voids around the various internal components, encasing these components. As such, the liner 20 serves to locate and retain the various internal components, minimizing or eliminating the need for typical retention components, such as brackets and/or mechanical fasteners. Furthermore, the shock-absorbing liner 20 aids in attenuating a force of impact to the PAPR 10, for example, when the PAPR 10 is dropped or strikes an object while in use. In order to achieve the desired shock-absorbing effect, the shock-absorbing liner 20 can be made of foam, such as polyurethane, or a similar material.

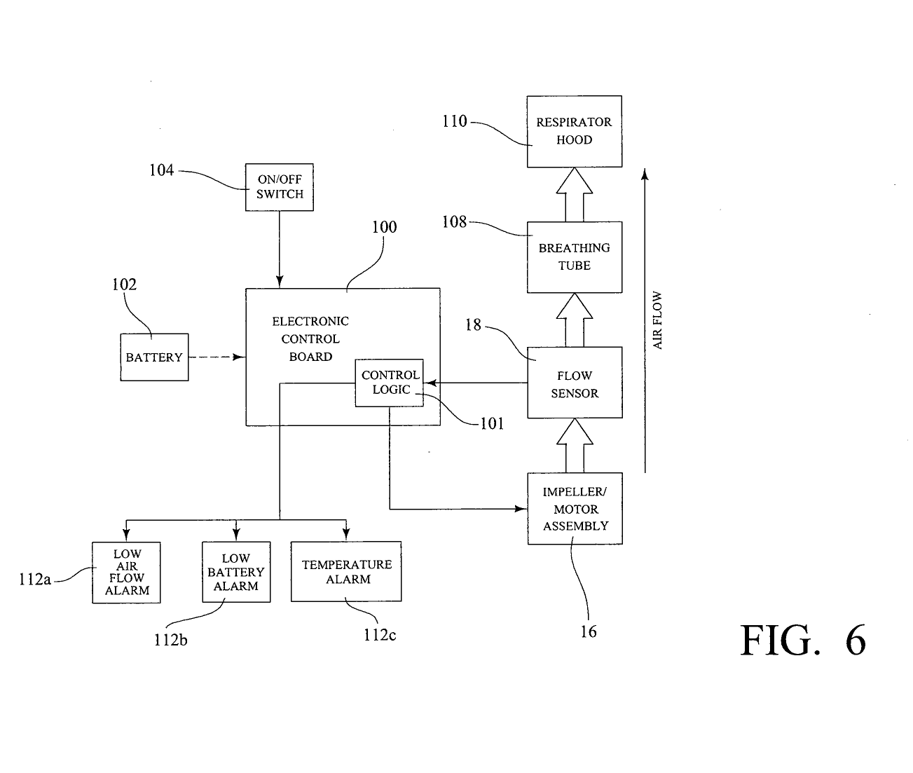

The shock-absorbing liner 20 also serves another important function, defining an air pathway 29 from the impeller/motor assembly 16 through the flow sensor 18 and to the air outlet 24. Specifically, air exits the impeller/motor assembly 16 through a first segment 29a of the air pathway 29 defined by the shock-absorbing liner 20, which directs that filtered air to and through the flow sensor 18. In this regard, the flow sensor 18 measures the mass flow rate, transmitting signals that are representative of the mass flow rate to the electronic control board 100, the importance of which is further described below with reference to FIG. 6.

It should also be recognized that the shock-absorbing liner 20 attenuates vibrations and aids in reducing noise produced by the PAPR 10. For example, assuming that the shock-absorbing liner 20 is made of polyurethane, at an air flow of 200 L/min, the impeller/motor assembly 16 generates a maximum noise level of 60 dBA, which is significantly lower than the noise generated by most common PAPRs.

Referring still to FIG. 5, once filtered air passes through the flow sensor 18, it continues through a second segment 29b of the air pathway 29, which directs that filtered air to the air outlet 24. In this regard, and as illustrated in FIGS. 1, 2, and 5, it is preferred that the PAPR 10 includes an adapter 30 for connecting an end of a breathing tube (not shown) to the air outlet 24. The second end of the breathing tube is then connected to a respirator hood or other headpiece (not shown) to deliver the filtered air to the user.

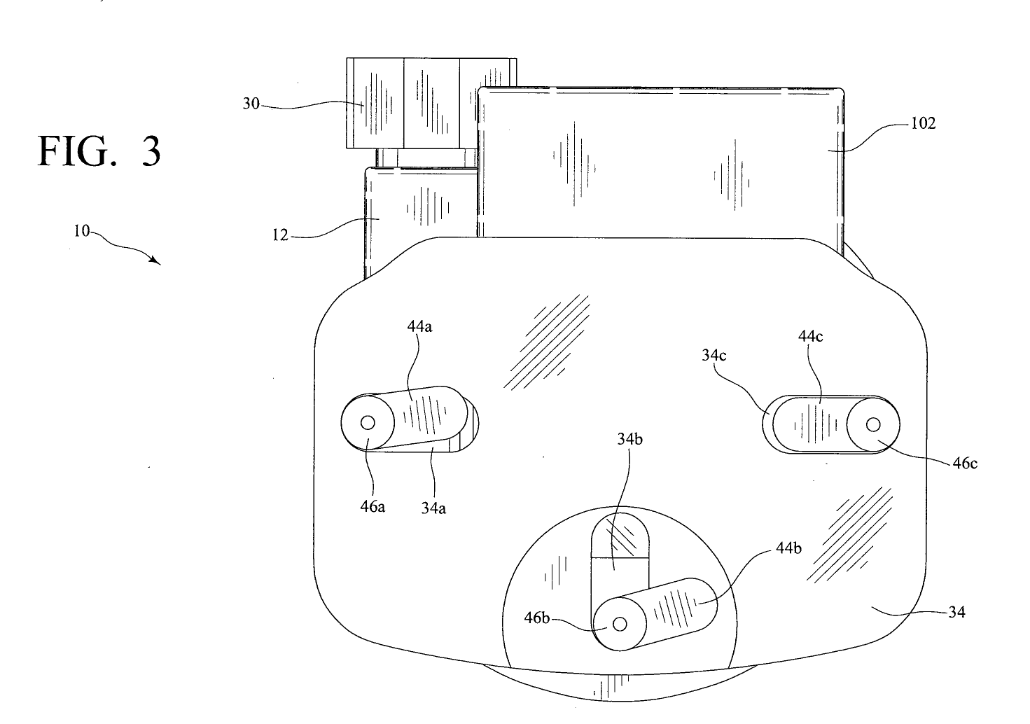

Referring now to the block diagram of FIG. 6, and as mentioned above with respect to FIG. 5, the exemplary PAPR 10 includes an electronic control board 100, which controls the operation of the PAPR 10. Specifically, the electronic control board 100 is powered by the battery 102 located on an external surface of the housing 12 (as shown in FIG. 3). The battery 102 is on the external surface of the housing 12 to allow a user to easily change batteries without disassembling the PAPR 10. One preferred battery 102 is a rechargeable lithium battery pack.

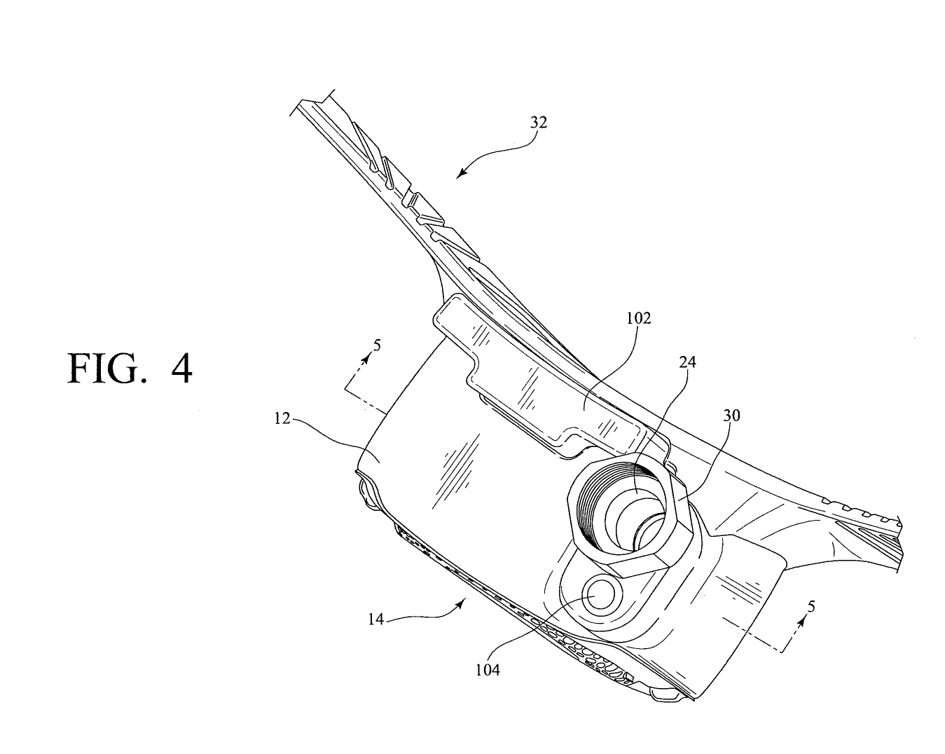

Referring still to the block diagram of FIG. 6 and the top view of FIG. 4, an on/off switch 104 is located on an external surface of the housing 12 so that it is accessible by the user. This on/off switch 104 is in electrical communication with the electronic control board 100, allowing the user to turn on the PAPR 10 by activating the impeller/motor assembly 16 or to turn off the PAPR 10 by deactivating the impeller/motor assembly 16. One preferred on/off switch 104 is manufactured and distributed by Schurter Inc. of Santa Rosa, Calif.—MSM 16 ST P/#1241.6611.1110000.

Referring again to the block diagram of FIG. 6, the electronic control board 100 receives signals from the flow sensor 18 that are representative of the mass flow rate of air through the PAPR 10. For example, one preferred flow sensor 18 is a Model No. AWM4300V Mass Air Flow Sensor manufactured by Honeywell International, Inc. of Morristown, N.J. Such signals are analyzed by control logic 101 on the electronic control board 100, with appropriate control signals then being sent to the impeller/motor assembly 16 to ensure and maintain a requisite air flow. In other words, the electronic control board 100 sends appropriate control signals to the impeller/motor assembly 16 based on the signals from the flow sensor 18 that are representative of the mass flow rate of air through the PAPR 10, such that there is a feedback loop to ensure a requisite air flow, for example, 7.0 CFM or 198 L/min. Accordingly, if the measured mass flow rate falls below a predetermined threshold, the electronic control board 100 will increase the speed of the impeller/motor assembly 16 to increase air flow through the PAPR 10, or if the flow rate exceeds a predetermined threshold, the electronic control board 100 will decrease the speed of the impeller/motor assembly 16. At the same time, and as a further refinement, it is also contemplated that the control logic 101 of the electronic control board 100 could be used to regulate air flow such that oscillations are not excessive, for example, do not exceed +/−0.25 CFM (7 L/min).

Referring still to the block diagram of FIG. 6, it is further contemplated that the electronic control board 100 will activate an audible and/or visible alarm upon occurrence of a predetermined condition to provide appropriate warning to the user. For example, if the air flow is too low (as determined by an analysis of the signals from the flow sensor 18), such as when the flow is equal to or less than 6.25 CFM (177 L/min), the electronic control board 100 will activate a low flow alarm 112a. For another example, if the remaining battery capacity falls below a predetermined level, such as less that 20 minutes of battery life, the electronic control board 100 will activate a low battery alarm 112b. For yet another example, if the battery temperature exceeds or falls below a predetermined threshold, such as above 50° C. or below 0° C., the electronic control board 100 will activate a temperature alarm 112c. Of course, such a temperature alarm would require the use of an additional sensor (not shown) to measure battery temperature and report such data to the electronic control board 100. Furthermore, various others types of alarms and alarm conditions could also be incorporated into the control logic 101 without departing from the spirit or scope of the present invention.

Finally, as also illustrated in FIG. 6 and as described above, once filtered air passes through the flow sensor 18, it continues to the air outlet 24, through a breathing tube 108 and to a respirator hood 110.

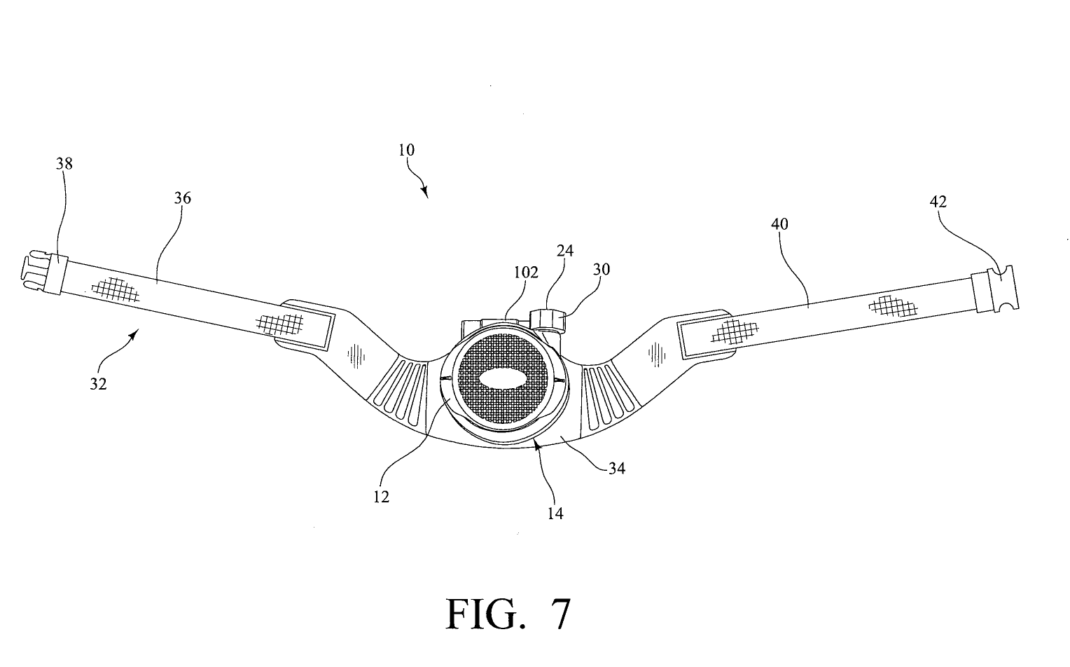

Referring now to FIGS. 3 and 7, the exemplary PAPR 10 may also be provided with a belt assembly 32 to secure the PAPR 10 to the user. In this exemplary embodiment, the belt assembly 32 includes a padded belt plate 34, a belt strap 36 with a male belt buckle 38 connected to one end of the belt plate 34, and a belt strap 40 with a female belt buckle 42 connected to the other end of the belt plate 34. The lengths of one or both of the respective belt straps 36, 40 are adjustable.

The PAPR 10 is secured or connected to the belt plate 34 through a plurality of lock levers 44a, 44b, 44c located on and extending from the back of the housing 12 of the PAPR 10, as best shown in FIG. 3. Each of the lock levers 44a, 44b, 44c can be rotated about a corresponding lever pivot 46a, 46b, 46c. The belt plate 34 defines a plurality of holes 34a, 34b, 34c corresponding to the plurality of lock levers 44a, 44b, 44c. Thus, to connect the PAPR 10 to the belt plate 34, the lock levers 44a, 44b, 44c are first aligned with the holes 34a, 34b, 34c. Next, the belt plate 34 is pressed against the back of the housing 12 of the PAPR 10 so that the lock levers 44a, 44b, 44c pass through the holes 34a, 34b, 34c. Finally, the lock levers 44a, 44b, 44c are rotated about the lever pivots 46a, 46b, 46c to secure and retain the belt plate 34 to the housing 12 of the PAPR 10. It is further contemplated that the lock levers 44a, 44b, 44c and the belt plate 34 may assist in securing the battery 102 to the housing 12.

One of ordinary skill in the art will recognize that additional embodiments are also possible without departing from the teachings of the present invention or the scope of the claims which follow. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A powered air purifying respirator, comprising:
a housing defining an air inlet and an air outlet;
a filter assembly operably connected to said housing at said air inlet for removing contaminants from air passing therethrough;
an impeller/motor assembly contained within said housing for drawing air through said air inlet and through said filter assembly;
a flow sensor contained within said housing for measuring air flow from said air inlet to said air outlet; and
a liner contained within said housing for aiding in attenuating a force of impact to said housing, said liner further defining an air pathway from said impeller/motor assembly through said flow sensor and to said air outlet.

2. The powered air purifying respirator of claim 1, and further comprising an electronic control board contained within said housing, said electronic control board receiving signals from said flow sensor that are representative of the air flow through the powered air purifying respirator and sending appropriate control signals to said impeller/motor assembly to ensure and maintain a requisite air flow.

3. The powered air purifying respirator of claim 2, and further comprising a battery to power said impeller/motor assembly and said electronic control board.

4. The powered air purifying respirator of claim 2, wherein said electronic control board activates an alarm upon occurrence of a predetermined condition.

5. The powered air purifying respirator of claim 1, wherein said liner is made of foam.

6. In a powered air purifying respirator, including a housing defining an air inlet and an air outlet, a filter assembly operably connected to said housing at said air inlet for removing contaminants from air passing therethrough, and an impeller/motor assembly contained within said housing for drawing air through said air inlet and through said filter assembly, the improvement comprising:
a shock-absorbing liner contained within said housing, said shock-absorbing liner defining an air pathway from said impeller/motor assembly to said air outlet.

7. The powered air purifying respirator of claim 6, wherein said shock-absorbing liner is made of foam.

8. The powered air purifying respirator as recited in claim 6, and further comprising a flow sensor contained within said housing and interposed between said impeller/motor assembly and said air outlet in the air pathway defined by said shock-absorbing liner.

9. The powered air purifying respirator as recited in claim 8, and further comprising an electronic control board, said electronic control board receiving signals from said flow sensor that are representative of a mass flow rate of air through the powered air purifying respirator and sending appropriate control signals to said impeller/motor assembly to ensure and maintain a requisite air flow.

10. The powered air purifying respirator as recited in claim 9, wherein said electronic control board is contained within said housing.

11. The powered air purifying respirator as recited in claim 9, and further comprising a battery to power said impeller/motor assembly and said electronic control board.

12. The powered air purifying respirator of claim 9, wherein said electronic control board activates an alarm upon occurrence of a predetermined condition.
